(19) United States
(12) Patent Application Publication
(10) Pub. No.: US 2019/0149310 A1
(43) Pub. Date: May 16, 2019

(54) Methods and Apparatus for Virtual Carrier Operation

(71) Applicant: MEDIATEK INC., Hsinchu (TW)

(72) Inventors: Pei-Kai Liao, Nantou County (TW); Hua-Min Chen, Beijing (CN)

(21) Appl. No.: 16/246,545

(22) Filed: Jan. 14, 2019

Related U.S. Application Data
(63) Continuation of application No. PCT/CN2017/096764, filed on Aug. 10, 2017.

(30) Foreign Application Priority Data
Aug. 12, 2016 (CN) PCT/CN2016/094871

(51) Int. Cl. H04L 5/00; H04W 76/10; H04W 72/04

(52) U.S. Cl. CPC H04L 5/0094; H04L 5/001; H04W 72/042; H04W 76/10; H04L 5/0042

(57) ABSTRACT

A narrow band operation under a larger carrier bandwidth for new radio (NR) system is proposed. The narrow band is named as a narrow virtual carrier (VC), i.e., a wider system bandwidth comprises multiple narrower virtual carriers, and virtual carrier is UE-specific. Further, a unified indication way for VC operation under different system bandwidth (BW) & subcarrier spacing is introduced. UE receives VC configuration from eNB, which comprises an offset direction, an offset value, and a VC BW. In addition, the UE receives VC ON/OFF command from the eNB to determine the activated VCs. Multiple VCs are aggregated by the UE, and the aggregating pattern is indicated by the eNB or determined by the UE.

### CROSS REFERENCE TO RELATED APPLICATIONS

This application is filed under 35 U.S.C. § 111(a) and is based on and hereby claims priority under 35 U.S.C. § 120 and § 365 (c) from International Application No. PCT/CN2017/096764, with an international filing date of Aug. 10, 2017, which in turn claims priority from International Application No. PCT/CN2016/094871, entitled “Methods and Apparatus for Virtual Carrier Operation” filed on Aug. 12, 2016. This application is a continuation of International Application No. PCT/CN2017/096764, which claims priority from International Application No. PCT/CN2016/094871. International Application No. PCT/CN2017/096764 is pending as of the filing date of this application, and the United States is a designated state in International Application No. PCT/CN2017/096764. This application claims priority under 35 U.S.C. § 120 and § 365(c) from PCT/CN2016/094871, entitled “Methods and Apparatus for Virtual Carrier Operation,” filed on Aug. 12, 2016. The disclosure of each of the foregoing documents is incorporated herein by reference.

### TECHNICAL FIELD

The present invention relates generally to wireless communication systems and, more particularly, to virtual carrier (VC) operation for new radio access technology (NR) systems.

### BACKGROUND

A Long-Term Evolution (LTE) system offers high peak data rates, low latency, improved system capacity, and low operating cost resulting from simple network architecture. An LTE system also provides seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred as user equipments (UEs). Enhancements to LTE systems are considered so that they can meet or exceed International Mobile Telecommunications Advanced (IMT-Advanced) fourth generation (4G) standard. One of the key enhancements is Carrier aggregation (CA), which is introduced to improve the system throughput.

Research/trial work has started in ITU, 3GPP, and other institutes/specification organizations/research groups on a global scale, to develop requirements and specifications for new radio (NR) systems, as in the Recommendation in ITU-R M.2083 “Framework and overall objectives of the future development of IMT for 2020 and beyond”. Compared to IMT-A system, ITU-R specifies that NR system is capable to provide 20 Gbps peak data rate, 100 Mbps user experienced data rate, and lms latency. To achieve these KPIs, larger bandwidth than those of earlier generation technologies (e.g., 3G in 5 MHz, 4G in 20 MHz), is one possible solution for delivery of important new capabilities.

Taking LTE system as an example, the supported maximal bandwidth is 20 MHz. Due to the bandwidth limitation, CA is proposed and deployed to improve data rate. Therefore, the NR system should be able to use any spectrum band ranging at least up to 100 GHz that may be made available for wireless communications even in a more distant future. As well known, larger bandwidth will require a larger FFT size calculation for an OFDM based system, which will result in larger power consumption. As a result, a narrow band operation under a larger carrier bandwidth for NR system is proposed. To differentiate enhanced machine type communication (eMTC) and narrow band Internet of Things (NB-IoT), such narrow band is named as a narrow virtual carrier (VC), i.e., a wider system bandwidth comprises multiple narrower virtual carriers, and virtual carrier is UE-specific.

### SUMMARY

A narrow band operation under a larger carrier bandwidth for new radio (NR) system is proposed. The narrow band is named as a narrow virtual carrier (VC), i.e., a wider system bandwidth comprises multiple narrower virtual carriers, and virtual carrier is UE-specific. Further, a unified indication way for VC operation under different system bandwidth (BW) & subcarrier spacing is introduced. UE receives VC configuration from eNB, which comprises an offset direction, an offset value, and a VC BW. In addition, the UE receives VC ON/OFF command from the eNB to determine the activated VCs. Multiple VCs are aggregated by the UE, and the aggregating pattern is indicated by the eNB or determined by the UE.

In one embodiment, a UE receives system information from a base station in a mobile communication network. An entire system bandwidth (BW) comprises a plurality of virtual carriers (VCs) each having a narrower BW. The UE establishes a radio resource control (RRC) connection with the base station over an anchor virtual carrier. The UE obtains a virtual carrier (VC) configuration from the base station over the RRC connection. The VC configuration comprises an offset direction, an offset value, and a VC bandwidth value of one or more VCs. The UE performs data reception and/or transmission with the base station over an aggregated VC BW based on the VC configuration.

In another embodiment, a base station transmits system information to a user equipment (UE) in a mobile communication network. An entire system bandwidth (BW) comprises a plurality of virtual carriers (VCs) each having a narrower BW. The base station establishes a radio resource control (RRC) connection with the UE over an anchor virtual carrier. The base station provides a virtual carrier (VC) configuration by the base station to the UE over the RRC connection. The VC configuration comprises an offset direction, an offset value, and a VC bandwidth value of one or more configured VCs. The base station performs data reception and/or transmission with the UE over an aggregated VC BW based on the VC configuration.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary wireless network with user equipments/mobile stations in accordance with embodiments of the current invention.

FIG. 2 illustrates a flow chart of UE in virtual carrier (VC) operation according to the embodiments of this invention.

FIG. 3A illustrates a first embodiment of VC bandwidth allocation under the same or different basic step size according to embodiments of this invention.

FIG. 3B illustrates a second embodiment of VC bandwidth allocation under the same or different basic step size according to embodiments of this invention.

FIG. 4A illustrates a first embodiment of VC allocation according to embodiments of this invention.

FIG. 4B illustrates a second embodiment of VC allocation according to embodiments of this invention.

FIG. 5A illustrates a first embodiment of VC aggregation pattern according to embodiments of this invention.

FIG. 5B illustrates a second embodiment of VC aggregation pattern according to embodiments of this invention.

FIG. 6A illustrates a first embodiment of VC ON/OFF command timing according to embodiments of this invention.

FIG. 6B illustrates a second embodiment of VC ON/OFF command timing according to embodiments of this invention.

FIG. 7 illustrates a sequence flow between a base station and a user equipment for VC operation according to embodiments of this invention.

FIG. 8 is a flow chart of a method of VC operation from UE perspective in accordance with one novel aspect.

FIG. 9 is a flow chart of a method of VC operation from eNB perspective in accordance with one novel aspect.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections. The making and using of the embodiments of the disclosure are discussed in detail below. It should be appreciated, however, that the embodiments can be embodied in a wide variety of specific contexts. The specific embodiments discussed are merely illustrative, and do not limit the scope of the disclosure. Some variations of the embodiments are described. Throughout the various views and illustrative embodiments, like reference numbers are used to designate like elements. Reference will now be made in detail to some embodiments of the invention, examples of which are illustrated in the accompanying drawings.

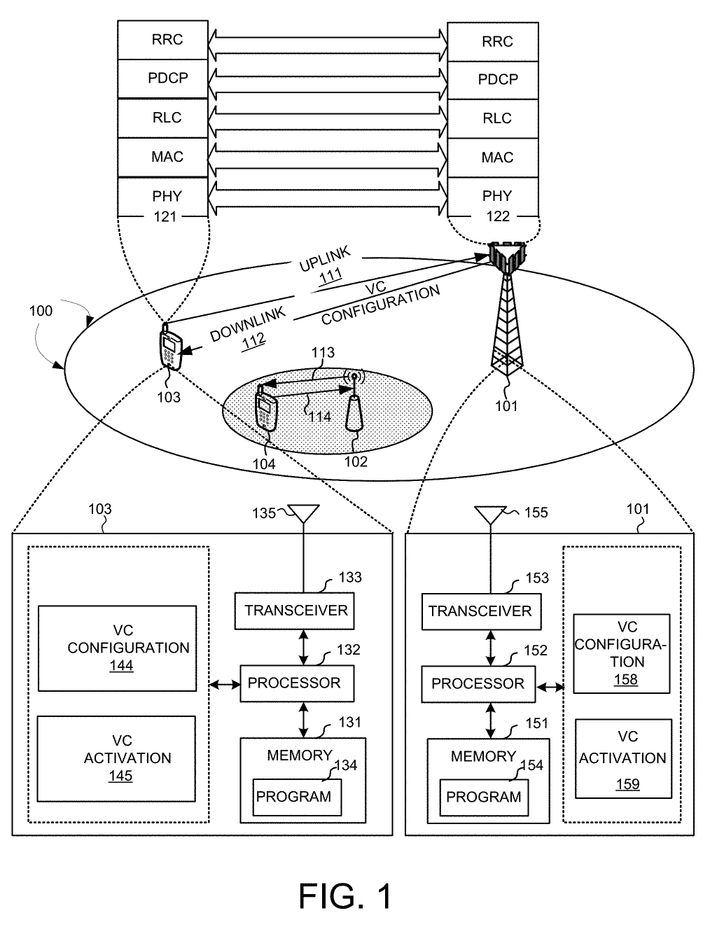

FIG. 1 illustrates an exemplary wireless network 100 with user equipments/mobile stations in accordance with embodiments of the current invention. Wireless communication system 100 includes one or more fixed base infrastructure units forming a network distributed over a geographical region. The base unit may also be referred to as an access point, an access terminal, a base station, a Node-B, an eNode-B (eNB), or by other terminology used in the art. In FIG. 1, the one or more base stations 101 and 102 serve a number of UEs 103 and 104 within a serving area, for example, a cell or a cell sector. The disclosure, however, is not intended to be limited to any particular wireless communication system.

Generally, serving base stations 101 and 102 transmit downlink communication signals 112 and 113 to UEs or mobile stations in the time and/or frequency domain. UEs or mobile stations 103 and 104 communicate with one or more base stations 101 and 102 via uplink communication signals 111 and 114. UE or the mobile station may also be referred to as a mobile phone, laptop, and mobile workstation and so on. In FIG. 1, the mobile communication network 100 is an OFDM/OFDMA system comprising a base station eNB 101 and eNB 102 and a plurality of UE 103 and UE 104. When there is a downlink packet to be sent from the eNB to the UE, each UE gets a downlink assignment, e.g., a set of radio resources in a physical downlink shared channel (PDSCH). When a UE needs to send a packet to eNB in the uplink, the UE gets a grant from the eNB that assigns a physical uplink shared channel (PUSCH) consisting of a set of uplink radio resources. The UE gets the downlink or uplink scheduling information from a new radio access technology (RAT) physical downlink control channel (NR-PDCCH), which is targeted specifically to NR UEs/mobile stations and has similar functionalities as legacy PDCCH, EPDCCH and MPDCCH. The downlink or uplink scheduling information and the other control information, carried by NR-PDCCH, is referred to as downlink control information (DCI).

FIG. 1 also shows an exemplary diagram of protocol stacks for control-plane for UE 103 and eNB 101. UE 103 has a protocol stack 121, which includes the physical (PHY) layer, the medium access control (MAC) layer, the radio link control (RLC) layer, the packet data convergence protocol (PDCP) layer, and the radio resource control (RRC) layer. Similarly, base station eNB 101 has a protocol stack 122, which includes the PHY layer, the MAC layer, the RLC layer, the PDCP layer, and the RRC layer, each of which connects with their corresponding protocol stack of UE protocol stack 121.

New radio (NR) systems should be able to use any spectrum band ranging at least up to 100 GHz that may be made available for wireless communications. However, larger bandwidth will require a larger FFT size calculation for an OFDM based system, which will result in larger power consumption. In one novel aspect, a narrow band operation under a larger carrier bandwidth for NR system is proposed. To differentiate enhanced machine type communication (eMTC) and narrow band Internet of Things (NB-IoT), such narrow band is named as a narrow virtual carrier (VC), i.e., a wider system bandwidth comprises multiple narrower virtual carriers, and virtual carrier is UE-specific. Further, a unified indication way for VC operation under different system bandwidth (BW) & subcarrier spacing is introduced. The VC configuration comprises an offset direction, an offset value, and a VC BW. Here, the offset direction is defined relative to the central frequency of an anchor virtual carrier, which is a default bandwidth for a UE to perform initial access; the offset value is based on a factor of a basic step; and the VC BW is also based on the basic step.

In the example of FIG. 1, eNB 101 indicates the VC configuration information comprising Offset direction+offset value+VC BW to UE 103 via downlink 112, and UE 103 determines the location of the configured VCs, and uses the aggregated VCs for data transmission/reception if multiple VCs are configured. Note that the VC configuration is UE-specific, and multiple VCs can be configured for each UE. As a result, each UE can operate within a set of aggregated UE-specific narrow bandwidth, relative to the large system bandwidth. Considering the design principle of VC operation, it's preferred to configure a set of consecutive resources in one embodiment, since the actual BW will be larger than the logical aggregated BW if the configured VCs are discrete.

In another novel aspect, the payload size for a specific VC configuration is unified, based on the proposed unified VC indication way. In another word, the payload size for a specific VC indication does not vary, and is independent to system BW and subcarrier spacing. The main design principle is to have different basic step value under different system bandwidth and subcarrier spacing in one embodiment, i.e., the basic step value is proportional to system BW. The offset value and VC BW is a multiple of the basic step value, respectively.

Using the above methods and system, flexible VC configuration under various system bandwidth and subcarrier spacing could be allowed. The VC configuration for example is denoted by 5 bits, the basic step for offset granularity: {5, 10, 20, 25, 40, 50} PRB. The basic step for offset granularity and subcarrier spacing should be known to UEs to determine VC location and VC BW. In this case, at most 5 VCs can be configured regardless of system bandwidth, and one VC BW can span over half bandwidth at most. In one embodiment, the DL/UL VC configuration are separate. The UL VC BW is restricted considering coverage and limited TX power. In another embodiment, the DL and UL VC is paired by a specific duplex gap.

FIG. 1 also shows simplified block diagrams of UE 103 and eNB 101 for virtual carrier (VC) operation in accordance with one novel aspect. UE 103 comprises memory 131, a processor 132, an RF transceiver 133, and an antenna 135. RF transceiver 133, coupled with antenna 135, receives RF signals from antenna 135, converts them to baseband signals and sends them to processor 132. RF transceiver 133 also converts received baseband signals from processor 132, converts them to RF signals, and sends out to antenna 135. Processor 132 processes the received baseband signals and invokes different functional modules and circuits to perform features in UE 103. Memory 131 stores program instructions and data 134 to control the operations of UE 103. The program instructions and data 134, when executed by processor 132, enables UE 103 to performs embodiments of the current invention.

Similarly, eNB 101 comprises memory 151, a processor 152, an RF transceiver 153, and an antenna 155. RF transceiver 153, coupled with antenna 155, receives RF signals from antenna 155, converts them to baseband signals and sends them to processor 152. RF transceiver 153 also converts received baseband signals from processor 152, converts them to RF signals, and sends out to antenna 155. Processor 152 processes the received baseband signals and invokes different functional modules and circuits to perform features in eNB 101. Memory 151 stores program instructions and data 154 to control the operations of eNB 101. The program instructions and data 154, when executed by processor 152, enables eNB 101 to perform embodiments of the current invention.

UE 103 and eNB 101 also comprise various function modules and circuits that can be implemented and configured in a combination of hardware circuits and firmware/software codes being executable by processors 132 and 152 to perform the desired functions. For example, each circuit or module may comprise the processor 132/152 plus corresponding software codes. In one example, UE 103 comprises a VC configuration module 144 and a VC activation module 145 to determine the VC BW and location based on VC configuration from eNB, to monitor signal on the configured VCs, and to activate or deactivate configured VCs. Similarly, eNB 101 comprises a VC configuration module 158 and a VC activation module 159 to determine VC configuration for UEs, to transmit the VC configuration to UEs, and to activate or deactivate configured VCs. In one novel aspect, one or multiple higher layer configured VCs can be muted by ON/OFF command. It is up to the network decision whether to deactivate some VCs for transmission. The ON/OFF command can be dynamic, as compared to semi-static VC configuration by higher layer.

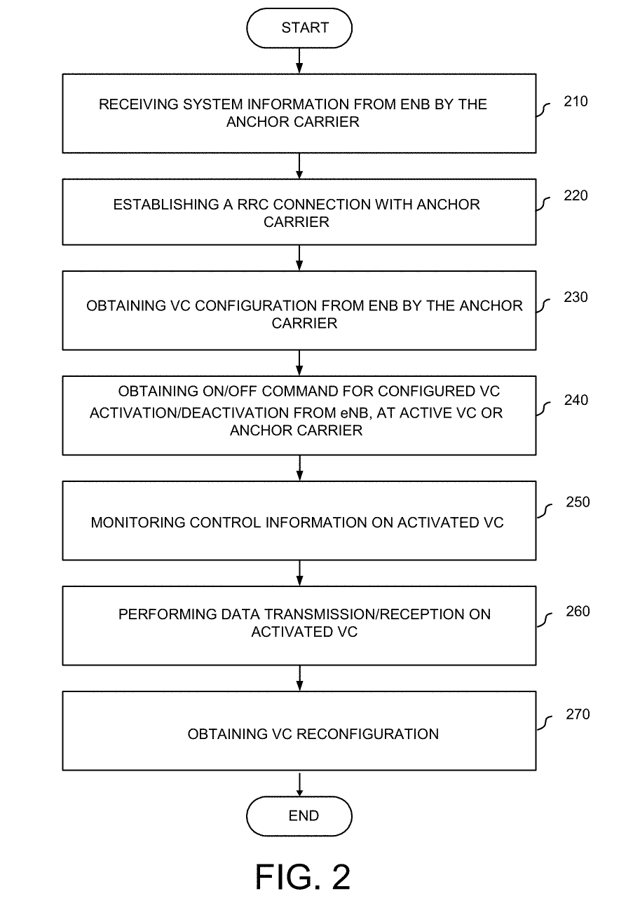

FIG. 2 illustrates a flow chart of UE in virtual carrier (VC) operation according to the embodiments of this invention. In step 210, UE receives system information from eNB the system information comprises: synchronization information, MIB, SIB, etc. In step 220, UE establishes RRC connection at an anchor virtual carrier. In step 230, UE obtains configuration about virtual carrier from eNB over the anchor virtual carrier. Optionally, in step 240, UE obtains ON/OFF command for VC activation from eNB. In one example, the ON/OFF command for VC activation is obtained from the anchor virtual carrier. In another example, the ON/OFF for VC activation or deactivation is obtained from the aggregated VCs. In step 250, UE monitors the control information transmitted on the aggregated UE-specific VCs (or UE-specific VC). If the eNB indicates the ON/OFF command to UE, then UE monitors the activated VCs for control information, and then performs data transmission/reception on the activated VCs in step 260. If necessary, UE could perform CSI measurement, and report the CSI to eNB. The CSI reporting is used for eNB for VC reconfiguration, and UE receives higher layer reconfiguration in step 270 to update the VC reconfiguration.

In this embodiment, the default anchor virtual carrier is also named as a common VC or central VC (CVC). Anchor virtual carrier can be defined as the virtual carrier containing synchronization signals, NR-MIB, NR-SIB1/2 UE. The anchor virtual carrier is used for initial cell access, such as NR system information transmission, including NR-sync, NR-MIB, and/or NR-SIB, and/or RRC connection setup. For NR systems, information about CVC BW is signaled in NR-MIB carried in PBCH, the center frequency of the CVC is the center frequency of the contained synchronization signals. To differentiate the anchor virtual carrier or CVC, the configured UE-specific VC is named dedicated VC (DVC).

For different system BW, the information about VC indication comprises an offset direction, an offset value, and a VC BW. If the offset direction is denoted by one bit, bit value of 0 means one direction from CVC central, and bit value of 1 means the opposite direction from the central frequency point of CVC. For the offset value field and the VC BW value field, two coefficients are given, and the offset value/VC BW are obtained by multiplying the coefficients with the basic step value. This VC indication format could be used in different system BWs and subcarrier spacing values, so it is called a unified indication way for VC configuration. Tables 1-4 depict embodiments of basic step size and VC number under different system BW with different subcarrier spacing.

TABLE 1
Basic step size and VC number under different
system BW with 15 KHz subcarrier spacing

| | | | Opt 1: | Opt 2: |
|---|---|---|---|---|
| System BW | | | Max VC #/ | Max VC #/ |
| (MHz) | FFT size | PRB # | basic step size | basic step size |
| 5 | 512 | 25 | 5/5 | 13/2 |
| 10 | 1024 | 50 | 5/10 | 17/3 |
| 20 | 2048 | 100 | 5/20 | 25/4 |
| 40 | 4096 | 200 | 5/40 | 40/5 |

TABLE 2
Basic step size and VC number under different
system BW with 60 KHz subcarrier spacing

| | | | Opt 1: | Opt 2: |
|---|---|---|---|---|
| System BW | | | Max VC #/ | Max VC #/ |
| (MHz) | FFT size | PRB # | basic step size | basic step size |
| 20 | 512 | 25 | 5/5 | 13/2 |
| 40 | 1024 | 50 | 5/10 | 13/4 |
| 80 | 2048 | 100 | 5/20 | 13/8 |
| 100 | 2048 | 125 | 5/25 | 13/10 |
| 160 | 4096 | 200 | 5/40 | 13/16 |
| 200 | 4096 | 250 | 5/50 | 14/18 |

TABLE 3
Basic step size and VC number under different
system BW with 240 KHz subcarrier spacing

| | | | Opt 1: | Opt 2: |
|---|---|---|---|---|
| System BW | | | Max VC #/ | Max VC #/ |
| (MHz) | FFT size | PRB # | basic step size | basic step size |
| 80 | 512 | 25 | 5/5 | 13/2 |
| 160 | 1024 | 50 | 5/10 | 13/4 |
| 320 | 2048 | 100 | 5/20 | 13/8 |
| 400 | 2048 | 125 | 5/25 | 13/10 |
| 800 | 4096 | 250 | 5/50 | 14/18 |

TABLE 4
Basic step size and VC number under different
system BW with 75 KHz subcarrier spacing

| | | | Opt 1: | Opt 2: |
|---|---|---|---|---|
| System BW | | | Max VC #/ | Max VC #/ |
| (MHz) | FFT size | PRB # | basic step size | basic step size |
| 25 | 512 | 25 | 5/5 | 13/2 |
| 50 | 1024 | 50 | 5/10 | 17/3 |
| 100 | 2048 | 100 | 5/20 | 25/4 |
| 200 | 4096 | 200 | 5/40 | 40/5 |

In Tables 1-4, 12 resource elements (REs) per physical resource block (PRB) in LTE system is assumed and PRB number under different system BW scales down/up with different subcarrier spacing, with a restriction as 4096 IFFT/FFT operation. For Option 1, the basic step value is set to be proportional to system BW. This way, the maximal VC number under different system BW and subcarrier spacing remains the same. The maximal VC number is 5 in this example. For Option 2, the basic step size is derived from legacy RBG size for resource allocation. As a result, different maximal VC number will be obtained under different cases. Further, the obtained maximal VC number under Option 2 is larger than that of Option 1. For example, if the basic step size is 2 PRBs for BW=5 MHz, the maximum number of VC is 13 in Table 1. Considering signaling overhead, Option 1 is more efficient and simple, which results in a unified payload to configure UE-specific VCs with the same maximal VC number under different system BW and subcarrier spacing. In the following embodiments, Option 1 is used as a design assumption, which means that the basic step size is dependent on the system BW and subcarrier spacing. Therefore, up to 5 VC can be configured in different system BWs, and each VC BW is a multiple of the basic step size.

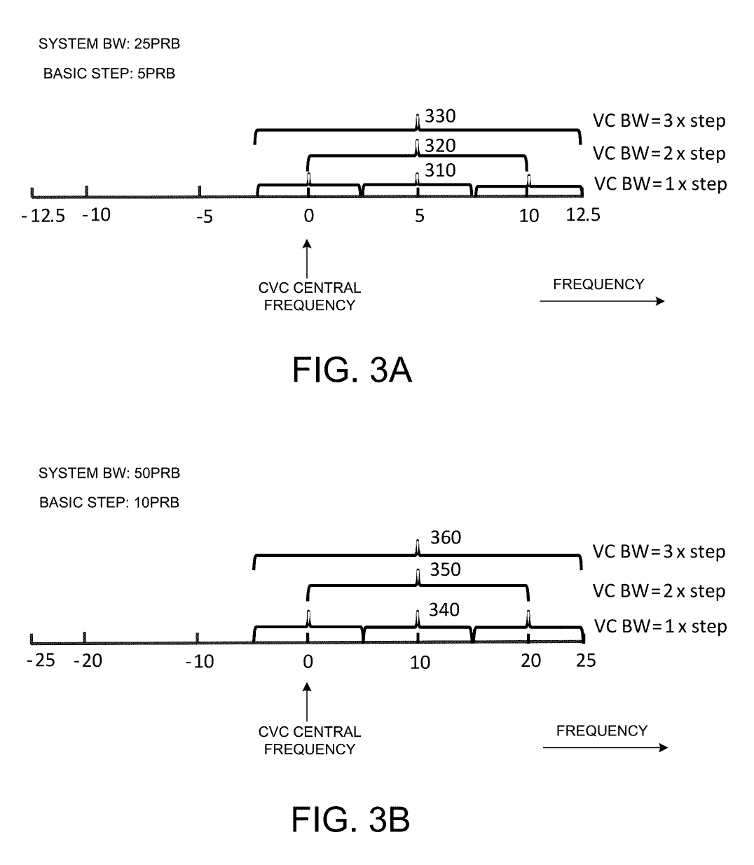

FIG. 3A illustrates a first embodiment of VC bandwidth allocation under the same or different basic step size according to embodiments of this invention. In FIG. 3A, the system BW is expressed as 25 PRBs, and the basic step size is 5 PRBs. For the VC BW=1× basic step size=SPRB, from the central to the right direction, 3 VCs, 310, 320 and 330 are depicted. VC 310 has a BW=1× basic step, has an offset=1× basic step to the central. VC 320 has a BW=2× basic step, has an offset=1× basic step to the central, while VC 330 has a BW=3× basic step, has an offset=1× basic step to the central. Here, the central is defined as the central frequency of system BW, or the center frequency of the CVC.

FIG. 3B illustrates a second embodiment of VC bandwidth allocation under the same or different basic step size according to embodiments of this invention. In FIG. 3B, the system BW is expressed as 50 PRBs, and the basic step size is 10 PRBs. For the VC BW=1× basic step size=10 PRB, from the central to the right direction, 3 VCs, 340, 350 and 360 are depicted. VC 340 has a BW=1× basic step, has an offset=1× basic step to the central. VC 350 has a BW=2× basic step, has an offset=1× basic step to the central, while VC 360 has a BW=3× basic step, has an offset=1× basic step to the central. Here, the central is defined as the central frequency of system BW, or the center frequency of the CVC.

To summarize VC configuration, the VC offset direction field could be 1-bit indication for two directions; the VC offset field is of several bits to indicate the offset value, which means the gap distance between the central of a configured VC and the central frequency point of system BW, by configuring a coefficient. Then, the offset value is obtained by multiplying the indicated coefficient with the basic step size, which depends on system BW/subcarrier spacing. The payload for this indication is, for example, 2 bits, because at most there could be 5 VC BW allocated and at most 3 VCs at one direction. For the VC BW, it is various, and extended by one or multiple basic step. Because there is up to 3× step size in one direction, for example the VC BW field could be expressed by 2 bits, i.e., a coefficient of the basic step size.

It should be noted that the basic step size should be known to UE when to determine VC location after receiving VC configuration. As described, the basic step size can be derived from a logical system BW by PRB number and subcarrier spacing. Since system BW may be various in NR system, it's preferred to configure the basic step value by higher layer message, but not to configure system BW.

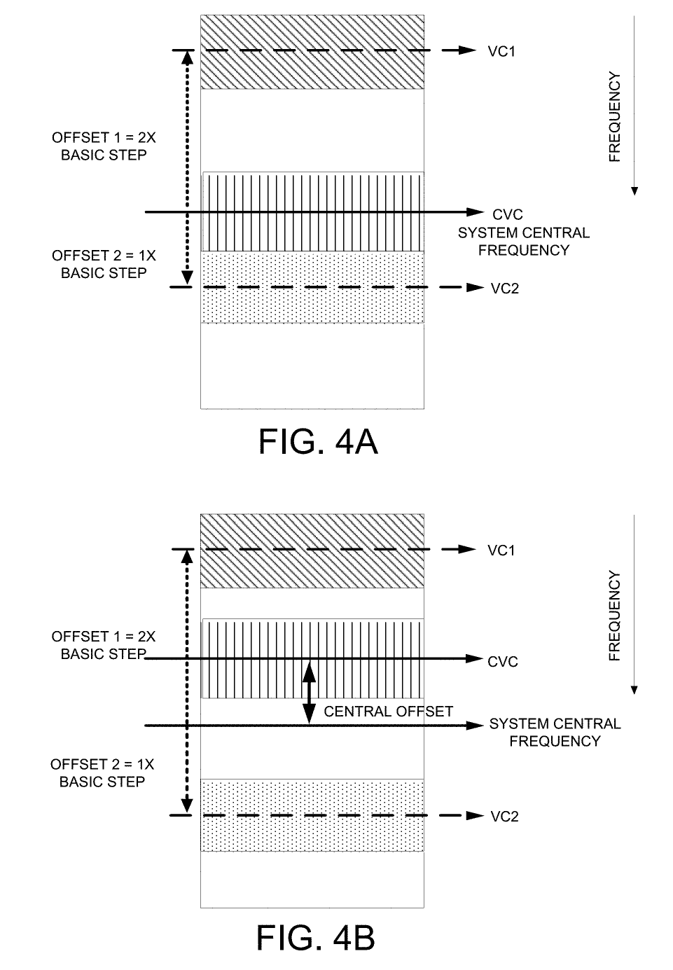

FIG. 4A illustrates a first embodiment of VC allocation according to embodiments of this invention. In FIG. 4A, CVC is located at the central of system BW, then, all VC configuration is based on the central frequency point of CVC. VC1 locates at a frequency point which has an offset of 2× basic step relative to the central, and the offset direction is from the central point to the upper side. For VC2, the offset value is 1× basic step, and the offset direction is from the central point to the down side. Here, VC1 BW and VC2 BW is assumed to be 1× basic step.

FIG. 4B illustrates a second embodiment of VC allocation according to embodiments of this invention. In FIG. 4B, CVC is not at the central point of system BW, i.e., there is an additional central offset between the central point of CVC and the central point of system BW. VC1 and VC2 location determination can be obtained by the same way as FIG. 4A, as long as the central offset is indicated to UEs.

If multiple VCs are configured to one UE, the configured multiple VCs will be aggregated to a set of radio resources for data transmission/reception. Multiple VCs are indexed logically according to the configuration, but regardless of frequency domain location, since UE may have no idea of the system bandwidth. These VCs are aggregated in a certain order. For example, a set of radio resources (e.g. PRBs) is obtained and indexed by aggregating configured VC1, VC2 and VC3 according to ascending VC index, i.e., VC1, VC2 and VC3, or according to a VC index order of VC2, VC1, VC3. In the latter way, the eNB should further indicate the VC index order for radio resource aggregation to UE, and the aggregating order could be UE-specific in one embodiment. Alternatively, a predefined aggregation order is applied to all UEs in another embodiment. Here, the predefined aggregation order can be a function of VC number, cell ID, UE ID (e.g., C-RNTI), subframe index, etc. In one example, for predefined aggregation order, the configured VCs are aggregated according to ascending VC index.

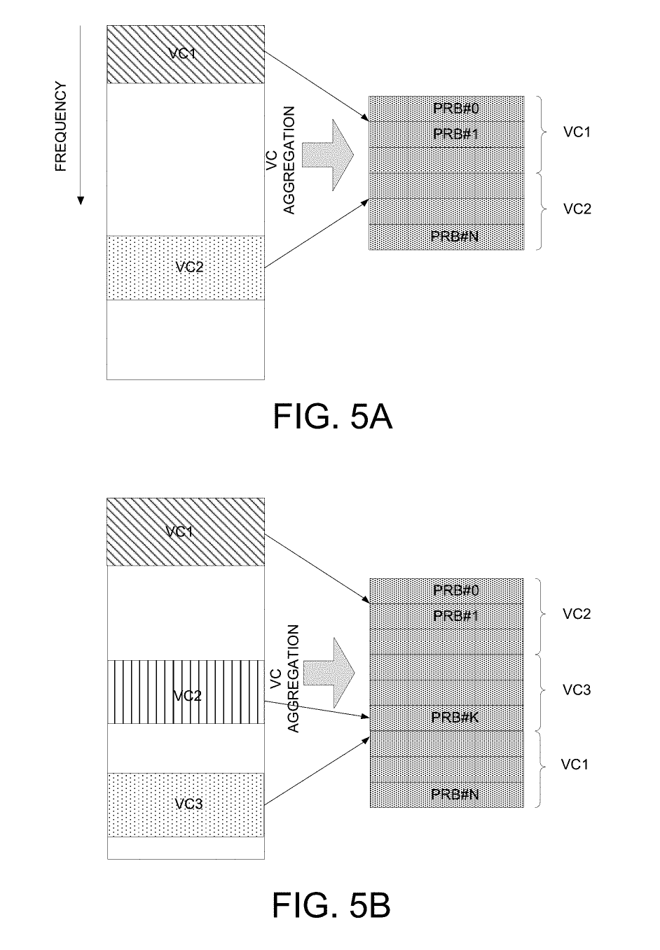

FIG. 5A illustrates a first embodiment of VC aggregation pattern according to embodiments of this invention. In FIG. 5A, VC1 and VC2 are configured to one UE. In this example, resources (e.g. PRBs) within the VCs are aggregated and indexed according to ascending VC index.

FIG. 5B illustrates a second embodiment of VC aggregation pattern according to embodiments of this invention. In FIG. 5B, VC1, VC2 and VC 3 are configured to one UE, and resources (e.g. PRBs) within the VCs are aggregated and indexed according to a VC index order of VC2, VC3, VC1, configured by the eNB. Then, the set of UE-specific logical resources for data transmission/reception is obtained as PRB #0˜PRB #N, regardless of system BW.

Under VC aggregation, logical resources for data transmission/reception is UE-specific. In another word, the aggregated VC BW is UE-specific and various. Considering a maximal 5 VC over system BW, Table 5 illustrates the aggregated VC BW under different aggregation levels with different basic step values. It's intuitive that resource allocation (RA) payload carried within DCI to indicate the exact resources for data transmission, varies with BW, which will result in various DCI payload. In one advantageous aspect, a unified RA payload determined by system BW is applied. However, it will reduce spectrum efficiency since UEs may only access a set of UE-specific aggregated BW, smaller than system BW. In another embodiment, RA payload varies with aggregated VC BW. Considering VC BW is various, it's proposed that RA payload is categorized into multiple groups by grouping aggregated VC BW.

TABLE 5
Aggregated BW under different aggregation levels

| Basic step | Aggregated BW by different aggregations levels of basic step | | | | |
|---|---|---|---|---|---|
| value | 1x | 2x | 3x | 4x | 5x |
| 5 | 5 | 10 | 15 | 20 | 25 |
| 10 | 10 | 20 | 30 | 40 | 50 |
| 20 | 20 | 40 | 60 | 80 | 100 |
| 25 | 25 | 50 | 75 | 100 | 125 |
| 40 | 40 | 80 | 120 | 160 | 200 |
| 50 | 50 | 100 | 150 | 200 | 250 |

As shown in Table 5, the different aggregated BW could be grouped together according to some criterion. The different aggregated BWs are grouped together according to the range of values. For example, values 5 and 10 are defined as group 1, values 15 and 20 are defined as group 2, values 30, 40, 50, 60 and 75 are defined as group 3, values 80 and 100 are defined as group 4, values 120 and 125 are defined as group 5, values 160 and 200 are defined as group 6, and value 250 is defined as group 6. The above grouping is an example, the above groups could be combined or separated based on different requirements. In this way of grouping, RA overhead is restricted into several levels.

To avoid too larger RA overhead, RA granularity should change with aggregated VC BW. Table 6 illustrates the RA granularity for different aggregated BW under RA type 2 or RA type 0 of LTE system. As depicted in Table 6, if the range of aggregated BW is within 10-25 PRB, the RA granularity could be set as 2 PRB, and the RA overhead is about 9 bits for type 2, and 13 bits for type 0, respectively. Using the adaptive RA granularity, the RA overhead could be maintained within a substantially similar range.

TABLE 6
RA granularity for different aggregated BW

| Aggregated BW | RA granularity | RA overhead |
|---|---|---|
| (PRB #) | (PRB #) | Type 2/Type 0 (bit) |
| <=10 | 1 | 6/10 |
| (10, 25] | 2 | 9/13 |
| (25, 75] | 3 | 12/25 |
| (75, 100] | 4 | 13/25 |
| (100, 150] | 6 | 14/25 |
| (150, 200] | 8 | 15/25 |
| (200, 250] | 10 | 15/25 |

To provide scheduling flexibility and further improve UE power consumption, configured VCs can be deactivated or activated through dynamic VC ON/OFF command, according to the network scheduling. Referring back to step 240 of FIG. 2, UEs should monitor VC ON/OFF command from eNB to determine the resources for data transmission and/or reception. Considering processing time and device settling time, the VC ON/OFF command is valid after K subframes from the timing position of receiving VC ON/OFF command.

In one embodiment, the container for the VC ON/OFF command is a UE-specific compact DCI dedicated for VC activation/deactivation. Such compact DCI is transmitted over a dedicated control channel, which can be CDM based to improve spectrum efficiency in one case. In another embodiment, the VC ON/OFF command is carried by a normal UE-specific DCI, wherein a bitmap is used for configured VC activation/deactivation. The bitmap length can be unified as the maximal VC number in one case, or varies according to the number of configured VCs. In a third embodiment, the VC ON/OFF command is indicated by a common signaling or DCI, broadcast to multiple UEs. For example, a bitmap with a unified length is used for each UE, and is carried by DCI format 3/3A, or carried by data channel, which is scheduled by common DCI. In this way, a common RNTI, which is cell-specific or group-specific, should be assigned to UEs. Further, UE index within the signaling is be signaled in one case, or is determined according to a predefined function, which is a function of UE ID, in another case.

In one embodiment, VC ON/OFF command transmission is cell-specific. In another word, such command is transmitted at cell-specific locations in time domain, no matter such command is UE-specific, group-specific or cell-specific. In another embodiment, VC ON/OFF command can be transmitted at UE-specific time positions, with a certain periodicity. The periodicity can be same or different for UEs.

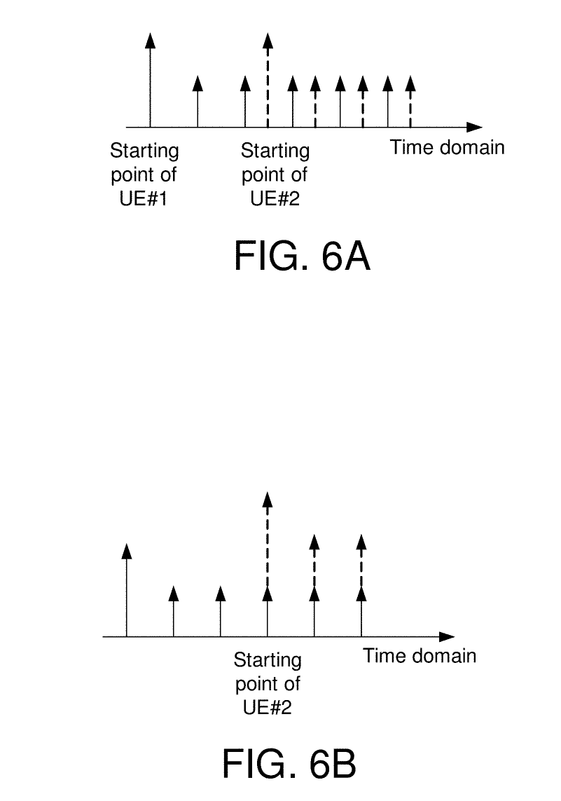

FIG. 6A illustrates a first embodiment of VC ON/OFF command timing according to embodiments of this invention. In FIG. 6A, assuming VC ON/OFF command periodicities for UE #1 and UE#2 are different, VC ON/OFF command for UE #1 is denoted by solid line, and VC ON/OFF command for UE #2 is denoted by dash line.

FIG. 6B illustrates a second embodiment of VC ON/OFF command timing according to embodiments of this invention. In FIG. 6B, the periods for different UEs are identical, and the time occasions are also identical. For example, VC ON/OFF command for UE #1 is denoted by solid line, and VC ON/OFF command for UE #2 is denoted by dash line. In this embodiment, the starting points for VC ON/OFF command monitoring are different for UE #1 and UE #2, but they share the same time occasions for VC activation/deactivation monitoring. Although time location is identical, the VC ON/OFF command for different UEs can be frequency division multiplexing (FDM), or code division multiplexing (CDM).

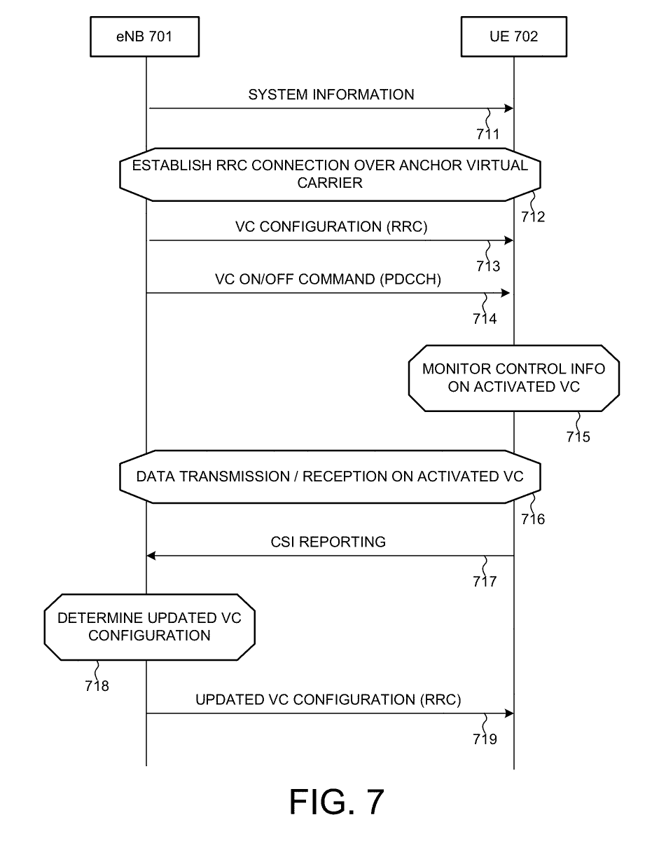

FIG. 7 illustrates a sequence flow between a base station eNB 701 and a user equipment UE 702 for VC operation according to embodiments of this invention. In step 711, eNB 701 broadcasts system information to UE 702. The system information comprises synchronization information, master information block (MIB), and a set of system information blocks (SIBs). In step 712, a radio resource control (RRC) connection is established between eNB 701 and UE 702 over an anchor virtual carrier. The default anchor virtual carrier is a common VC or central VC (CVC), which is used for initial access, such as system information transmission, synchronization, MIB/SIB, and/or RRC connection setup. In step 713, eNB 701 transmits VC configuration over the higher layer RRC signaling. The VC configuration is UE specific, comprises configuration information of offset direction, offset value, and VC bandwidth for one or more configured VCs. Optionally, in step 714, eNB 701 transmits VC ON/OFF command to UE 702 for activating and/or deactivating some of the configured VCs. To provide scheduling flexibility and to improve UE power consumption, configured VCs can be deactivated or activated through dynamic VC ON/OFF command via PDCCH. In one example, the VC ON/OFF command is obtained from the anchor virtual carrier. In another example, the VC ON/OFF command is obtained from the aggregated VCs. In step 715, UE 702 monitors control information transmitted on the aggregated VCs. If the eNB indicates VC ON/OFF command to the UE, then the UE monitors control information on the activated VCs. In step 716, UE 702 performs data transmission and reception on the activated VCs. In step 717, UE 702 performs CSI measurement and reports CSI to eNB 701. In step 718, eNB 701 determines updated VC configuration based on the CSI reporting. In step 719, eNB 701 transmits updated VC configuration over the higher layer RRC signaling.

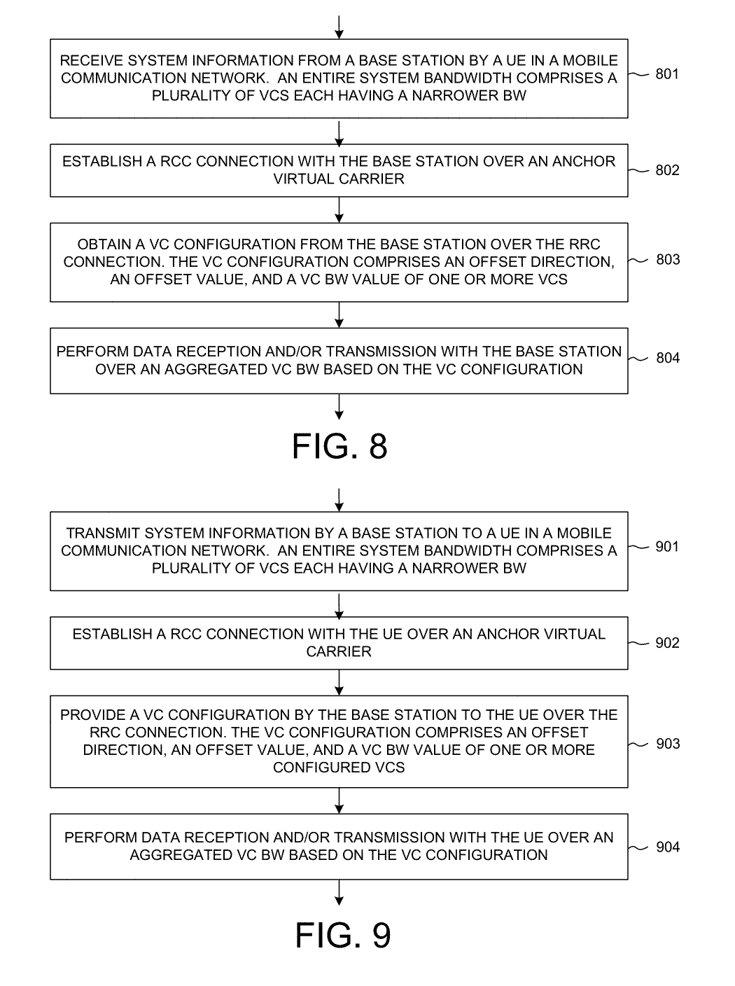

FIG. 8 is a flow chart of a method of VC operation from UE perspective in accordance with one novel aspect. In step 801, a UE receives system information from a base station in a mobile communication network. An entire system bandwidth (BW) comprises a plurality of virtual carriers (VCs) each having a narrower BW. In step 802, the UE establishes a radio resource control (RRC) connection with the base station over an anchor virtual carrier. In step 803, the UE obtains a virtual carrier (VC) configuration from the base station over the RRC connection. The VC configuration comprises an offset direction, an offset value, and a VC bandwidth value of one or more VCs. In step 804, the UE performs data reception and/or transmission with the base station over an aggregated VC BW based on the VC configuration.

FIG. 9 is a flow chart of a method of VC operation from eNB perspective in accordance with one novel aspect. In step 901, a base station transmits system information to a user equipment (UE) in a mobile communication network. An entire system bandwidth (BW) comprises a plurality of virtual carriers (VCs) each having a narrower BW. In step 902, the base station establishes a radio resource control (RRC) connection with the UE over an anchor virtual carrier. In step 903, the base station provides a virtual carrier (VC) configuration by the base station to the UE over the RRC connection. The VC configuration comprises an offset direction, an offset value, and a VC bandwidth value of one or more configured VCs. In step 904, the base station performs data reception and/or transmission with the UE over an aggregated VC BW based on the VC configuration.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Time Division Synchronous Code Division Multiple Access (TD-SCDMA), Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, TD-SCDMA, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A method comprising:
receiving system information from a base station by a user equipment (UE) in a mobile communication network, wherein an entire system bandwidth (BW) comprises a plurality of virtual carriers (VCs) each having a narrower BW;
establishing a radio resource control (RRC) connection with the base station over an anchor virtual carrier;
obtaining a virtual carrier (VC) configuration from the base station over the RRC connection, wherein the VC configuration comprises an offset direction, an offset value, and a VC bandwidth value of one or more VCs; and
performing data reception and/or transmission with the base station over an aggregated VC BW based on the VC configuration.

2. The method of claim 1, wherein the offset value and the VC bandwidth are determined from multiples of a basic step value.

3. The method of claim 2, wherein the basic step value is proportional to the entire system bandwidth.

4. The method of claim 2, wherein the basic step value equals five physical resource blocks (PRBs), wherein the offset value is a first multiple of the basic step value, and wherein the VC BW is a second multiple of the basic step value.

5. The method of claim 2, wherein the VC configuration is provided by a unified VC indication wherein a payload size for a specific VC indication remains the same under different system BW and subcarrier spacing.

6. The method of claim 1, further comprising:
receiving a VC ON/OFF command from the base station; and
determining a number of activated VCs from the one or more configured VCs to from the aggregated VC BW.

7. The method of claim 1, further comprising:
reporting channel state information (CSI) to the base station; and
determining whether to update the VC configuration over the RRC connection in response to the CSI reporting.

8. The method of claim 1, wherein the UE aggregates multiple VCs based on an aggregation pattern, wherein the aggregation pattern is indicated by the base station or is predefined.

9. A User Equipment (UE), comprising:
a radio frequency transceiver that receives system information from a base station in a mobile communication network, wherein an entire system bandwidth (BW) comprises a plurality of virtual carriers (VCs) each having a narrower BW;
a radio resource control (RRC) layer entity that establishes an RRC connection with the base station over an anchor virtual carrier;
a configuration circuit that obtains a virtual carrier (VC) configuration from the base station over the RRC connection, wherein the VC configuration comprises an offset direction, an offset value, and a VC bandwidth value of one or more VCs; and
a processor that performs data reception and/or transmission with the base station over an aggregated VC BW based on the VC configuration.

10. The UE of claim 9, wherein the offset value and the VC bandwidth are determined from multiples of a basic step value.

11. The UE of claim 10, wherein the basic step value is proportional to the entire system bandwidth.

12. The UE of claim 10, wherein the basic step value equals five physical resource blocks (PRBs), wherein the offset value is a first multiple of the basic step value, and wherein the VC BW is a second multiple of the basic step value.

13. The UE of claim 10, wherein the VC configuration is provided by a unified VC indication wherein a payload size for a specific VC indication remains the same under different system BW and subcarrier spacing.

14. The UE of claim 9, wherein the UE receives a VC ON/OFF command from the base station and determines a number of activated VCs from the one or more configured VCs to from the aggregated VC BW.

15. The UE of claim 9, wherein the UE reports channel state information (CSI) to the base station and determines whether to update the VC configuration over the RRC connection in response to the CSI reporting.

16. The UE of claim 1, wherein the UE aggregates multiple VCs based on an aggregation pattern, wherein the aggregation pattern is indicated by the base station or is predefined.

17. A method comprising:
transmitting system information by a base station to a user equipment (UE) in a mobile communication network, wherein an entire system bandwidth (BW) comprises a plurality of virtual carriers (VCs) each having a narrower BW;
establishing a radio resource control (RRC) connection with the UE over an anchor virtual carrier;
providing a virtual carrier (VC) configuration by the base station to the UE over the RRC connection, wherein the VC configuration comprises an offset direction, an offset value, and a VC bandwidth value of one or more configured VCs; and
performing data reception and/or transmission with the UE over an aggregated VC BW based on the VC configuration.

18. The method of claim 17, wherein the offset value and the VC bandwidth are determined from multiples of a basic step value, and wherein the basic step value is proportional to the entire system bandwidth.

19. The method of claim 17, further comprising:
transmitting a VC ON/OFF command by the base station to the UE, wherein a number of activated VCs from the one or more configured VCs form the aggregated VC BW.

20. The method of C claim 17, further comprising:
transmitting an aggregation pattern by the base station to the UE, wherein multiple VCs are aggregated to from the aggregated VC BW.
